(19) United States
(12) Patent Application Publication
(10) Pub. No.: US 2026/0280450 A1
(43) Pub. Date: Sep. 17, 2026

(54) ENERGY HARVESTING SWITCH INTEGRATED WITH MULTIPLE GATEWAYS TO CABIN NETWORK

(71) Applicant: BAE Systems Controls Inc., Endicott, NY (US)

(72) Inventor: John Yaron, Eynon, PA (US)

(21) Appl. No.: 19/075,981

(22) Filed: Mar. 11, 2025

(51) Int. Cl. H02N 11/00; B64D 45/00; H04B 7/185

(52) U.S. Cl. CPC H02N 11/002; B64D 45/00; H04B 7/18506; B64D 2045/0085; B64D 2221/00

(57) ABSTRACT

A system and method using push-button energy harvesting (EH) switch devices for controlling devices in an aircraft vehicle, and for dynamically receiving and responding to switch events. The EH switch devices transmit EH switch wireless datagram messages responsive to corresponding EH switch actuations. A gateway transceiver at the aircraft receives and performs a real-time analysis of all EH datagram messages including screening detected EH messages based on a database of commissioned devices. The datagram payload data includes a sequence counter to combat any record-and-replay spoofing attacks. A control processor uses a memory to track reception sequencing for all preconfigured EH switch devices. The sequence counter is transmitted by the EH switch for every commissioned unit and is tracked by the control processor using the memory. If a sequence value received is less than or equal to the last detected sequence value for a particular device, an error message is flagged.

### BACKGROUND

This disclosure is directed to human machine interfaces in a vehicle such as an aircraft or aerospace vehicle, and more particularly airplane user-operated cabin components that are controllable using an integrated energy harvesting switch in communication with multiple receiving gateway devices in the aircraft/aerospace vehicles.

Aircraft original equipment manufacturers (OEMs) are always looking to reduce cost, complexity of electrical circuit wiring. They are also motivated to improve reliability and flexibility of their products. Wiring is heavy. Connectors are expensive. A significant reliability problem is open circuits in the electrical wiring. When open circuits happen in wiring, it is difficult to locate the open connection to allow for repairs. Eliminating wiring and connectors is a significant benefit.

In typical commercial airline/aircraft vehicles, passenger cabin systems utilize push-buttons for attendant call function and for operating reading lights and other passenger comfort accessories. There is a significant amount of wiring and connectors needed to operate these functions or components. Moreover, sometimes it is desired to add new push button controls for users and this represents challenges as added new wiring is costly.

### SUMMARY

A system and method that implements energy harvesting switches integrated with multiple gateway receiver units for operating equipment and performing functions in aircraft/aerospace vehicles.

A system and method that implements wireless messaging from energy harvesting push-button switches in an aircraft and aerospace vehicle to eliminate hard-wire connectors and wires for push-button human machine interface controls.

A system, method and computer program product to facilitate provision of services for passengers in an aircraft passenger cabin, the system implementing energy harvesting push-button switches using wireless datagram messaging to operate passenger accessory equipment in a passenger cabin of an aircraft or aerospace vehicle, the energy harvesting push-button switches interfacing with multiple gateway receiver units in the aircraft/aerospace vehicles using encrypted wireless communications.

A system, method and computer program product to facilitate provisioning of services for passengers in an aircraft passenger cabin, the system implementing energy harvesting push-button switches to operate equipment in a passenger cabin of an aircraft or aerospace vehicle and implementing an approach including the encrypting of energy harvesting push-button switch payloads and utilization of multiple gateways to handle a large number of switches.

A system, method and computer program product to facilitate operation of electronic equipment, accessories and services for multiple passengers in an aircraft passenger cabin, the system implementing energy harvesting push-button switches interfacing with equipment used by passengers in a passenger cabin of an aircraft or aerospace vehicle, the energy harvesting push-button switches interfacing with multiple gateway receiver units in the aircraft/aerospace vehicles using encrypted wireless communications therewith.

In an embodiment, the energy harvesting switch approach provides wireless messaging from push-buttons and adds encrypted payloads that cannot be spoofed and replayed.

In an embodiment, each gateway receiver unit in the aircraft/aerospace vehicle monitors all the switches in the aircraft and sends the commands back to a cabin system central processor. This solution allows for large scale, secure, monitoring of hundreds of switches and requires no connectors, wires, or batteries.

In an embodiment, each multiple gateway receiver unit in the aircraft/aerospace vehicle is connected to a cabin experience network by Power-Over-Ethernet.

In an embodiment, each gateway receiver unit and electronic energy harvesting switch is configurable using wireless near field communication (NFC) whereby a technician can place the energy harvesting (EH) switch near the gateway receiver device to program it with security keys for the aircraft fail number.

In one aspect, there is provided a switch monitoring system for an aircraft/aerospace vehicle. The switch monitoring system comprises: multiple push-button energy harvesting switches, each push-button energy harvesting switch associated with a user-activated device in the aircraft/aerospace vehicle, each push-button energy harvesting switch having a transmitter adapted to generate a wireless data message responsive to push-button energy harvesting switch actuation; a wireless gateway receiver, located in the aircraft/aerospace vehicle, the wireless gateway receiver configured for receiving wireless data messages from corresponding push-button energy harvesting switches of associated user-activated devices, the wireless gateway receiver having a hardware processor associated with a memory storing program instructions, the hardware processor running the program instructions configuring the hardware processor to: parse a received wireless data message to obtain a message payload data; detect, from the obtained message payload data, an identity of the push-button energy harvesting switch that generated the wireless data message and its corresponding user-activated device; parse the received wireless data message to determine a message count parameter; and validate the received wireless data message based on the determined message count parameter, wherein multiple push-button energy harvesting switches are monitored in the aircraft/aerospace vehicle without use of a battery or a wire connection.

In a further aspect, there is provided a method for monitoring switches in an aircraft/aerospace vehicle. The method comprises: receiving, at a wireless gateway receiver located in the aircraft/aerospace vehicle, wireless data messages from corresponding multiple push-button energy harvesting switches, each push-button energy harvesting switch associated with a user-activated device in the aircraft/aerospace vehicle and having a transmitter adapted to generate a wireless data message responsive to push-button energy harvesting switch actuation; parsing, using a hardware processor at the wireless gateway receiver, the received wireless data message to obtain a message payload data; detecting, from the obtained message payload data, using the hardware processor, an identity of the push-button energy harvesting switch that generated the wireless data message and its corresponding user-activated device; parsing, by the hardware processor, the received wireless data message to determine a message count parameter; and validating, by the hardware processor, the received wireless data message based on the determined message count parameter, wherein multiple push-button energy harvesting switches are monitored in the aircraft/aerospace vehicle without use of a battery or a wire connection.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows a general diagram depicting an aircraft or aerospace vehicle having a passenger cabin including a plurality of passenger seats (nodes) each integrated with a push-button energy harvesting (EH) switch according to an embodiment of the present invention;

FIG. 2A shows a schematic block diagram of the push-button energy harvesting switch employed in the aircraft in an example implementation;

FIG. 2B shows an alternative embodiment of the push-button energy harvesting switch employed in the aircraft in an example implementation;

FIG. 2C depicts a conceptual structure of the data telegram communicated as an independent, self-contained datagram output message in an embodiment;

FIG. 3A shows a schematic block diagram of an EH gateway receiver device for receiving and processing EH switch messages from each push-button energy harvesting switch device configured in the aircraft vehicle;

FIG. 3B shows a further portion of the energy harvesting gateway receiver device including the MuC microprocessor that performs configuration and provisioning of EH switch using an integrated NFC reader;

FIG. 4 depicts a method which runs in the radio frequency microcontroller to process received telegrams in accordance with an embodiment;

FIG. 5 depicts method operations for verifying the data telegram using the resolvable private address according to an embodiment;

FIG. 6 shows an exemplary embodiment of a data telegram payload having data including: the current sequence counter value incremented for each telegram sent; the EH switch status value reporting the current push-button switching action; and the resulting security signature used to authenticate radio telegrams;

FIG. 7 depicts an authentication method that calculates a 32-bit telegram signature according to an embodiment;

FIG. 8 depicts an algorithm execution sequence to verify authentication signature via

RFC 3610 based block cipher mode according to an embodiment; and

FIG. 9 conceptually depicts the secure commissioning of custom EH switch using NFC protocol.

### DETAILED DESCRIPTION

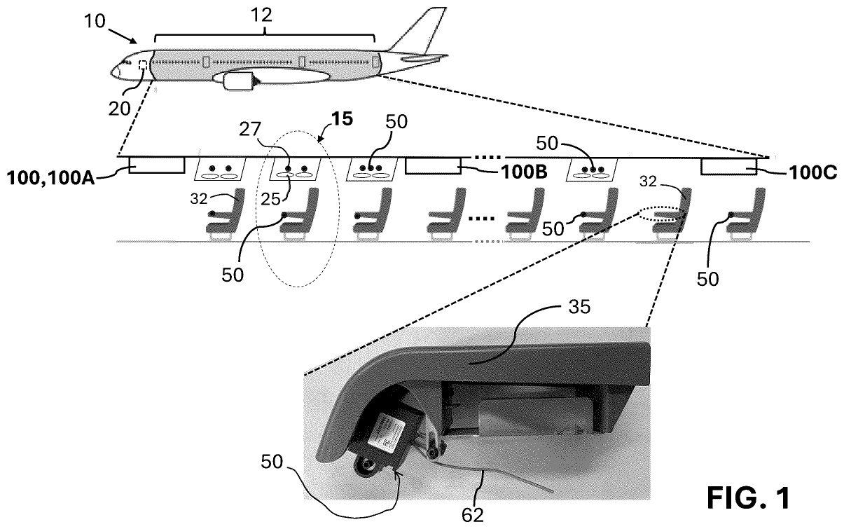

FIG. 1 shows a general diagram depicting an airplane or aircraft/aerospace vehicle 10 having a passenger cabin 12 including a plurality of passenger seats (seat nodes) 15 each seat node integrated with one or more push-button energy harvesting (EH) switches 50 in accordance with an embodiment of the present invention. Each seat node 15 is provided for an individual passenger and or flight attendant in the aircraft and each EH switch 50 includes communications connectivity to a central controller or microprocessor (“central processor”) of a Cabin Management System (CMS) 20 adapted in a system(s) (not shown) for controlling operations at the passenger seat node 15 to effect personal passenger comforts at the seat node 15 using switch devices, and for recording switch operations. Particularly, the CMS 20 provides the interface for the cabin crew to monitor and control aircraft functions related to the cabin including, but not limited to: cabin illumination, passenger signs and passenger/attendant calls, galley and lavatory controls and cabin intercommunication devices.

According to an aspect of the present disclosure, the cabin management system 20 receives communications for controlling systems and devices for enhancing passenger comforts and experiences at the passenger seat node 15 in the passenger cabin including, but not limited to: control of user-activated devices such as individual passenger reading lights, provision of an attendant call function to communicate with a flight attendant, or other controls that might be added for other cabin system features. For example, in view of FIG. 1, in the passenger cabin 12, at each seat node 15, there is provided one or more of user-activated device control switches such as a control switch 27 activated by a user for provisioning a command signal(s) to control an overhead lighting unit and dimmable reading light(s) 25 for providing a flight attendant call function or for other functions.

According to an aspect of the present disclosure, each control switch 27 is an energy-harvesting switch 50 providing wireless datagram messaging used to turn on/off/control the function at an seat node 15. For example, as shown in FIG. 1, at a seat node arm 35 of a passenger seat assembly 32, there is provided an energy-harvesting switch 50 providing a connection for providing command signal(s) to control the overhead lighting unit and dimmable reading light(s) 25. Alternately, or in addition, an energy-harvesting switch 50 can be provided at the passenger seat node arm to provide an attendant call control function. In an embodiment, each energy harvesting switch 50 includes circuitry powered by the energy harvesting generator responsive to action of a mechanical push-button to generate and send a datagram packet wirelessly via an antenna without use of batteries, nor use of a power connection, nor use of any energy storage device. As a consequence, an amount of electrical connections and the amount of physical wiring in the aircraft is reduced.

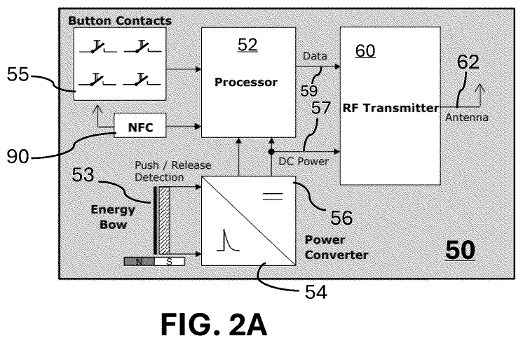

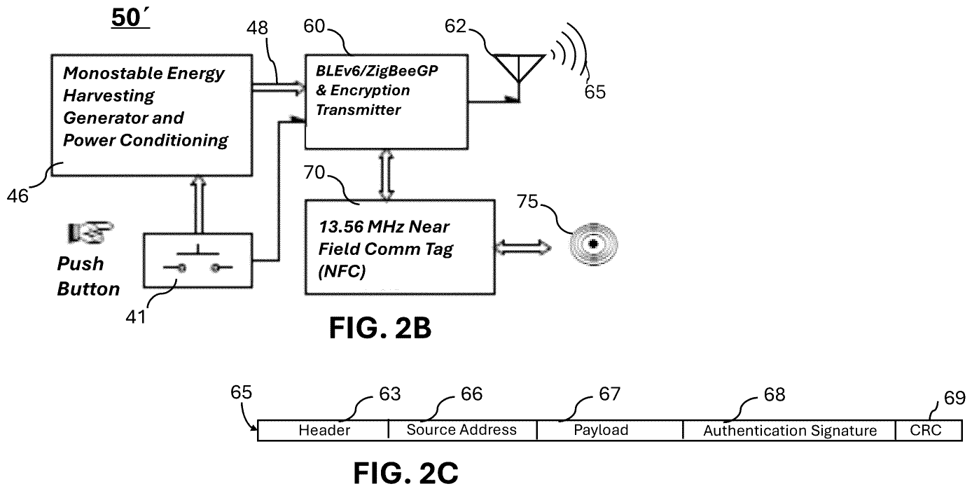

FIG. 2A shows a general block diagram of the push-button energy harvesting (EH) switch 50 (alternatively referred to as “EH switch”) employed in the aircraft 10. An energy bow/power generator element 54 converts the push/release motion of the energy bow 53 into electrical energy and the electro-dynamic energy converter element 56 converts the energy of the power generator element 54 into a stable DC supply voltage 57 to power the device electronics. The energy bow is pushed by an appropriate push button or switch rocker (not shown). In an embodiment, an internal spring will release the energy bow as soon as it is not pushed down anymore. When the energy bow is pushed down, electrical energy is created and a Bluetooth radio telegram is transmitted which identifies the action (i.e., pressed or not pressed) and identifies the status of one or more button contacts 55 provisioned at the EH switch. Releasing the energy bow 53 similarly generates energy which is used to transmit a different radio telegram. Thus, it is therefore possible to distinguish between radio telegrams sent when the energy bow is pushed and radio telegrams sent when the energy bow is released.

An EH switch includes a processor 52 that determines the status of the button contacts 55 (for switch rocker identification) and the energy bow 53, encodes this status into a data structure 59, generates the proper radio telegram structure and sends it to the RF transmitter 60 that transmits the data in the form of a series of short 2.4 GHz Bluetooth Low Energy (BLE) radio telegrams using the integrated antenna 62. By identifying these different telegram types and measuring the time between pushing and releasing of the energy bow 53, it is further possible to distinguish between “Long” and “Short” button contact presses.

Additionally, as shown in FIG. 2A, there is provided a wireless near-field communications (NFC) interface module 90 that permits for reading and writing of certain product parameters using an NFC compliant reader/writer supporting NFC tags (e.g., a Forum Type 2 tag as specified by ISO/IEC 14443 standard). In one embodiment, the energy harvesting switch can provide, e.g., four button contacts 55 which can be grouped into two channels (e.g., Channel A and Channel B) each containing two button contacts (e.g., State 0 and State 1). The state of all four button contacts (pressed or not pressed) is transmitted together with a unique device identification (multibit device ID) whenever the energy bow 53 is pushed or released.

FIG. 2B shows schematic block diagram of a push-button energy harvesting switch 50′ employed in the aircraft 10 according to an alternative embodiment. This EH switch 50′ of FIG. 2B includes a push-button device 41 connected to built-in energy harvesting circuitry 46 that transforms the mechanical energy of the push-button actuation into electrical energy 48 which is harvested in a manner to generate a low-energy wireless signal 65 (hereinafter a “BLE datagram” or “data telegram” or “datagram”). In one embodiment, the EH switch 50′ can include a push-button transmitter module, e.g., available from EnOcean GmbH. This data telegram 65 is transmitted as a wireless signal and received by circuitry (not shown) adapted to control a mechanical actuator, a switch, or a controller to initiate operations, e.g., turning on/off or controlling devices or appliances at the seat node within the airplane vehicle passenger cabin. The activation state (e.g., press state or release state) of the push-button 41 can invoke operation of a built-in energy harvesting circuitry 46, i.e., an electro-dynamic energy generator, adapted to provide a low-energy signal, e.g., approximately three-hundred micro-Joules of energy. The built-in energy harvesting circuitry 46 is coupled with a RF transmitter 60 to generate an encrypted wireless Bluetooth Low Energy (BLE) data telegram 65 that can be received at a wireless transceiver at an energy harvesting (EH) switch gateway (ESG) receiver device which forms an Energy Harvesting System (EHS). In an embodiment, the RF transmitter 60 can be a ZigBee protocol-based transmitter device (e.g., ZigBee GP (Green Power) protocol) capable of transmitting an encrypted wireless datagram. In an embodiment, the built-in energy harvesting circuitry 46 is a monostable energy harvesting generator that includes power conditioning functionality such as rectifying, regulating, filtering or isolating. The built-in energy harvesting circuitry 46 interfaces with the RF transmitter 60 and integrated antenna 62, the RF transmitter 60 and integrated antenna 62 being configured to transmit a wireless datagram message (alternatively referred to as “wireless data message”) according to a Bluetooth Low-Energy communications protocol (BLEv5) or ZigBee protocol.

In an embodiment, the EH switch 50/50′ can transmit two types of wireless data messages: a data telegram 65 and a commissioning telegram. The payload of data telegrams contains the EH switch status, a current sequence counter value and a resulting authentication signature. The payload of the commissioning telegrams contains a private security key as well as a current value of the sequence counter and the device address. As will be described, the sequence counter is used to combat any record-and-replay spoofing attacks by a potentially nefarious listening hacker.

In an embodiment, the data telegram (datagram) 65 can be transmitted according to a wireless communications protocol, e.g., I.E.E.E. 802.15.4, and the message is transmitted as a telegram in the 2.4 GHz band. The RF transmitter 60 can be further configured to encrypt the wireless datagram messages, e.g., using an advanced encryption standard (AES)-128 encryption technique. In embodiments, the energy harvesting switch 50/50′ can transmit wireless data messages as single frequency, narrow-band, frequency shift keying signals at approximately 900 MHz.

FIG. 2C depicts a structure of the data telegram 65 communicated as an independent, self-contained wireless datagram message that, in a non-limiting embodiment, includes the following fields: a header field 63 that can include a preamble field to identify a start of the BLE frame, an access address used to identify the radio telegram type and a field for identifying certain radio telegram parameters; a source address field 66 for uniquely identifying the EH switch device and which supports two source address modes: a static source address mode and a resolvable private address mode where the source address changes for each transmission; and a telegram payload field 67 of message payload data that can include a switch status, a current sequence counter value and a resulting authentication signature 68, or when configured as a commissioning telegram, include a private security key, the current sequence counter value and the device address. The telegram payload field 67 can further include an encoding of the switch push-button status, e.g., a button push action or button release action. The wireless data message can further consist of a BLE checksum 69 used by the ESG receiver device to verify data integrity of the received BLE radio telegram that is calculated as a CRC (cyclic redundancy check) of the BLE header, source address and message payload data fields.

In an embodiment, the EH switch sends wireless data messages sporadically on different wireless bands. For example, for reliability reasons, the EH switch device 50/50′ can generate several message events for each button input and transmits the same data telegram 65 on three selected radio channels with minimum delay in between for each button press. In view of FIG. 1, the airplane is provided with one or more EH switch gateway receiver devices 100, each with three BLE transceivers 150A, 150B, 150C configured to receive the wireless data message transmission along the respective three selected radio channels to ensure receipt of the wireless data message from a push-button EH switch at a gateway receiver device.

According to an aspect of the present disclosure, as shown in FIG. 1, each energy harvesting switch 50 sends wireless datagram messages for receipt by one or more electronic energy harvesting (EH) switch gateway (ESG) receiver devices 100, each ESG receiver device configured to monitor all the switches in the aircraft and send the commands back to the cabin management system 20 central processor. For reliable reception, multiple ESG receiver devices 100 can be provided to receive the wireless data messages from multiple EH switches 50. In a non-limiting example embodiment shown in FIG. 1, three ESG receiver devices 100 are shown located at various locations in the passenger, e.g., a separate EH gateway receiver device 100A, 100B, 100C at respective front passenger cabin portion, middle cabin portion and back cabin portion, each ESG receiver device configured with an interface to allow for large scale, secure, monitoring of hundreds of energy harvesting switches 50 throughout the cabin that requires no connectors, wires, or batteries.

With more particularity, each ESG receiver device 100 uses Power-over-Ethernet (POE) Interface to easily connect to other aircraft vehicle systems, e.g., the Cabin Experience Network (CEN). Each ESG receiver device 100 decrypts wireless data messages and forwards to the main processor of the cabin management system 20. The ESG receiver device 100 is multi-protocol (e.g., BLEv5, Zigbee, and can include a daughter card for handling other protocols).

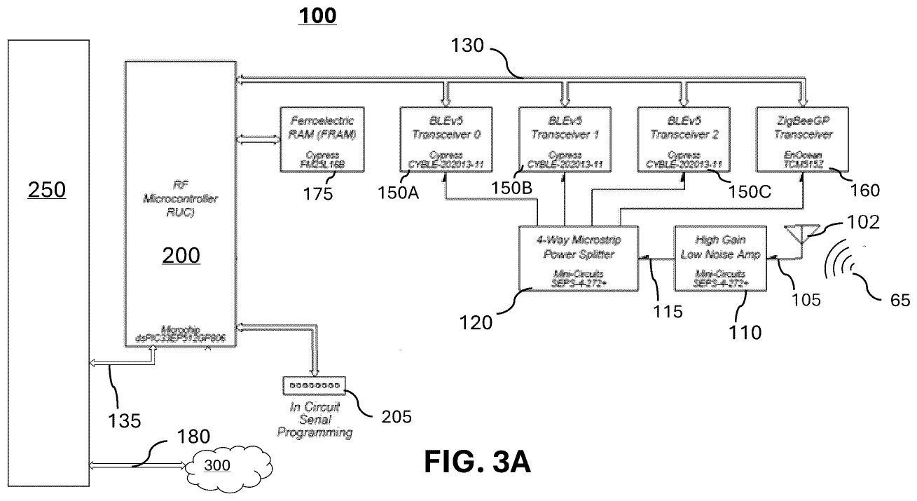

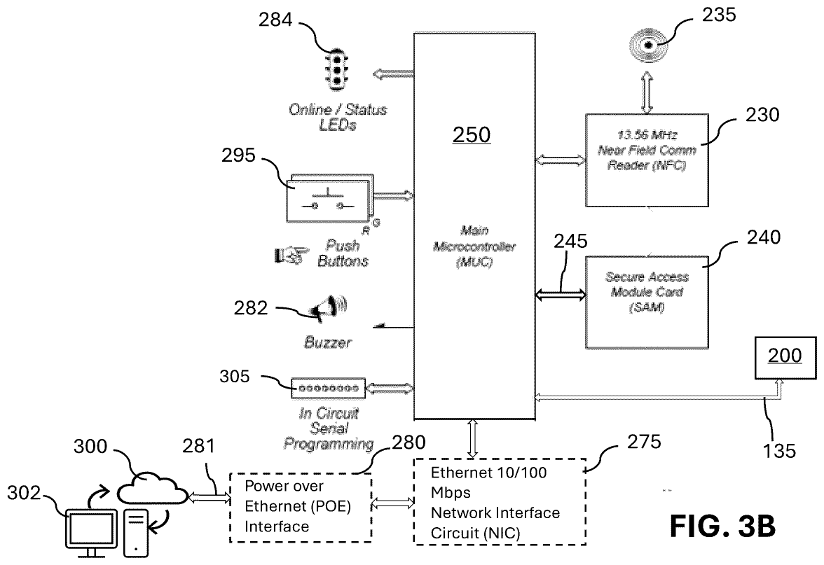

FIG. 3A shows a schematic block diagram of an ESG (Gateway) receiver device 100 for receiving and processing EH switch wireless datagram messages from each switch device configured in the aircraft vehicle. In an embodiment, each ESG receiver device 100 includes at least a dedicated radio frequency (RF) decryption microcontroller or processor (RF μC or RUC) 200 to capture/process all received datagrams 65 received from an EH switch. In an embodiment, as each EH switch 50/50′ sends datagrams 65 sporadically on different wireless bands, the ESG receiver device 100 is configured to ensure receiving all broadcast datagrams and provide a gateway from the EH switches to a cabin experience network (CEN) 300 which is a high speed fiber optic ethernet network intended to connect up many Ethernet based devices like displays, cameras, data concentrators, network attached storage systems, servers, switches, passenger service units, etc. The RUC 200 is thus a dedicated processor to capture all wireless traffic so that no wireless datagrams are missed. In an embodiment, the RUC 200 interfaces with a further main processor/microcontroller unit (MUC) 250 via communications interface channel 135. The MUC 250 performs tasks such as communicating with the CEN 300 via an Ethernet interface 180 and perform other tasks such as sending results back to the main or centralized cabin control system processor or controller of the cabin management system.

As shown in FIG. 3A, the ESG receiver device 100 is a Energy Harvesting switch Gateway (ESG) having a configuration of multiple transceiver devices, including in a non-limiting embodiment, a triplex of BLE transceivers (e.g., BLEv5) transceivers 150A, 150B, 150C for redundancy, and a ZigBee GP protocol transceiver 160 that each interfaces with the RUC 200 via a communications data/address bus 130. Although not shown, the ESG receiver device 100 includes a ZigBee-to-BLE telegram transformation unit such that wireless data messages received according to the ZigBee wireless messaging protocol can be transformed into BLE telegram message suitable for gateway device parsing. In view of FIG. 3A, each ESG receiver device 100 in the aircraft vehicle includes a gateway receiver antenna 102 for receiving datagrams 65 from each EH switch 50 and a high gain, low noise amplifier 110 for amplifying received wireless signals 105 from the gateway receiver antenna 102. The amplified wireless data message signals 115 are input to a 4-way microstrip power splitter 120 for splitting the received input signal into four equal phase signals, a respective split signal being input to a respective transceiver, e.g., BLEv5 transceivers 150A, 150B, 150C. A fourth split signal output from the 4-way microstrip power splitter 120 is input to the ZigBee GP protocol transceiver 160. Each respective BLE transceiver 150A, 150B, 150C and ZigBee GP protocol transceiver 160 communicates with RF microcontroller (RUC) 200 for interpreting, in real-time, received low power wireless data messages from the EH switches. A single master ESG receiver device 100 of the multi-ESG topology can be configured for identifying and sorting any redundant telegrams when the three BLE and ZigBee transceivers receive the same datagram 65. In an embodiment, for each EH switch 50/50′, the wireless data message is only sent one time so dedicated signal processing is provided on all bands to ensure not to miss the one-time wireless data message associated with a EH switch push-button press.

With more particularity, the RUC 200 performs real-time analysis of all EH switch wireless data messages relayed to it from the BLE transceivers 150A, 150B, 150C and ZigBee protocol transceiver 160 and in particular screens detected EH wireless data messages from the transceivers based on a database of commissioned devices supplied by the MUC 250. In an embodiment, a sequence counter can be provided in the encrypted payload of the datagram payload which the gateway receiver can analyze and determine if it has increased since the last reception from that specific EH switch. Any record and replay attacks are then mitigated and can be identified to alert of a hack attempt. In an embodiment, a non-volatile memory buffer with high endurance (i.e., can be written/read many times) for each supported EH switch 50/50′. In an embodiment, the ESG receiver device 100 uses an integrated, non-volatile, high-read/write-endurance, ferro-electric RAM (FRAM) to track reception sequencing for all preconfigured EH devices. The ferro-electric random-access-memory (FRAM) module 175 in the ESG receiver device 100 can have greater than 1e12 read/write endurance but any memory device that will retain all sequencing information during any ESG power loss can be implemented. In a non-limiting implementation, the ESG receiver device houses specific security keys referred to as Identity Resolution Keys (IRKs) that allows determining the switch identity. The FRAM module thus forms a database that is configured to hold the IRKs of many EH switch devices, e.g., up to 128 or more commissioned EH devices, and executes high-speed, optimized, machine-language assembly-code routines for AES128 encryption/decryption to expeditiously identify receptions from any EH device within its database. These IRKs are saved to the ESG database during NFC commissioning.

In an embodiment, this sequencing memory remains intact during any power loss. If the ESG receiver device 100 is powered down, and then a transmission is recorded, and then the ESG is powered back up, and then the replay hack of that recording (while the ESG was offline) is generated, the hack will be accepted. Thus, if the ESG loses power, it is required to receive a couple or a few receptions (within a certain time frame) from an EH switch before it is qualified to be secure. The qualifications can be stored in volatile memory.

In an embodiment, transmitted data telegrams 65 are obfuscated in order to prevent tracking of switches radio transmissions. This can be achieved by using resolvable private addresses (RPA) as defined in the Bluetooth Core Specification. For example, the EH switch 50 can be configured to use resolvable private addresses (NFC configurable option) by setting the RPA address mode flag within a configuration register (not shown). When using resolvable private addresses, the address used by the EH switch 50 can be modified (e.g., rotated) for each transmission according to a defined scheme. Authorized receivers sharing a specific security key with the EH switch allows determining the device identity. The shared security key that allows determining the switch identity is known by both EH switch 50 and the authorized receiver as the Identity Resolution Key (IRK). An EH switch 50 IRK key can be modified via the NFC configuration interface. In an embodiment, optionally, the datagram payload data can be 32-bit authenticated using the configured IRK via AES128 encryption/decryption. Resolvable Private Addressing (RPA) is also optionally supported using the configured IRKs via AES128 encryption/decryption to obfuscate the origins of any EH device transmissions.

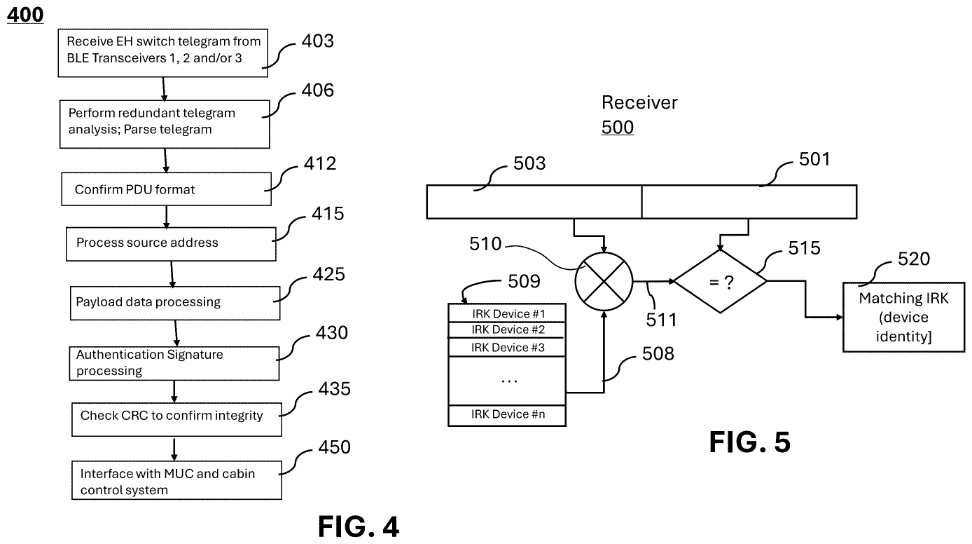

FIG. 4 depicts a method 400 run at the RUC 200 to process received data telegrams 65. At 403, there is depicted the step of the RUC receiving the data telegram 65 from an EH switch 50. As there are three redundant transceivers, the RUC 200 can conduct an analysis of the received redundant telegrams at 406 to ensure identifying the data telegram 65 and once received, the RUC can parse the received telegram and at 412 confirm the protocol data unit (PDU) format. In an embodiment, the RUC 200 identifies and sorts any redundant telegrams received by the transceivers and will process a single identified wireless datagram message associated with a single switch actuation event.

Continuing at 415, FIG. 4, the RUC processes the source address of the received data telegram 65 in order to identify the switch which has been pressed. As it is desirable to obfuscate the origins of the EH Switch telegram in order to prevent tracking of its radio transmissions, the resolvable private address (RPA) mode is implemented. In this implementation, the address used by the EH switch is modified (i.e., rotated) according to a defined scheme which on one hand precludes determining the switch device identity by unauthorized receivers while allowing authorized receivers sharing a specific IRK with the EH switch to determine the switch identity. This shared IRK key is modifiable via the NFC configuration interface.

In an embodiment, for each data telegram transmitted by an EH switch 50 (i.e. for every button push or release), a new resolvable private address is generated. This resolvable private address can be embodied by a fixed-bit address field, e.g., 48 bits, split into two sub-fields: a “prand” (i.e., random number) field: which field (e.g., 24 bits) contains a random number and which prand value is changed for each telegram that is transmitted. Individual advertising events used to transmit one telegram use the same prand value; and a “hash” field: which field (e.g., 24 bits) contains a verification value (hash) generated from prand using the IRK.

For source address processing, the prand value is encrypted using the shared IRK security key. The lowest 24 bit of the result (encrypted value) are then used as hash. The concatenation of 24 bit prand and 24 bit hash can be transmitted as 48 bit private resolvable source address. The r FRAM module 175 or like memory storage database is thus configured as a database that maintains a list of IRK for all transmitters that have been commissioned to work with it.

FIG. 5 depicts method operations 500 for verifying the data telegram using the resolvable private address. The receiver will try for each locally stored IRK if the hash generated matches the hash part of the resolvable private address field of the received telegram. If it does, then the IRK identifies the device from which this telegram originated. As shown in FIG. 5, whenever the RUC 200 at the receiver receives a data telegram with a resolvable private address, it will itself successively generate a hash 501 (e.g., 24 bit) from the 24 bit corresponding prand address 503 sequentially using each IRK 508 known to it in database 509 (i.e., the IRK 508 of each device that has been learned into it). If, at 515, FIG. 5, if the RUC determines that an IRK matches, that is, when the corresponding prand address 503 is encoded with the IRK 508, e.g., using an AES128 operation at 510, and the computed new hash value result 511 will match the hash 501, then the receiver at 520 has established the IRK used by the transmitter and thereby the identity of the transmitter of the associated EH switch used to generate this resolvable private address. Thus, conceptually the IRK takes the role of the device address of the transmitter while the corresponding prand address 503 and the hash 501 fields provide a mechanism for the receiver to select the correct IRK among the set of IRK 508 known to it. In the scenario that a computed hash value is not equal to the corresponding hash value portion of the resolvable private address included in the wireless data message payload, then the method obtains a new unique shared security Identity Resolution Key 508 (a new IRK) from the FRAM module 175 or like memory storage database and computes a new hash value result 511 using an AES128 operation at 510 based on the new IRK 508 and the corresponding private (prand) address 503 (e.g., 24 bit). Then, the method will compare the two values and detect whether the computed new hash value is equal to the corresponding hash value portion of the resolvable private address included in the wireless data message payload. These steps of obtaining a new IRK 508, computing the new hash value result 511 based on the IRK 508 and detecting whether the computed new hash value is equal to the hash 501 of the corresponding resolvable private address included in the wireless data message payload are repeated until such time as the computed new hash value result 511 is equal to the hash 501 of the corresponding resolvable private address included in the wireless data message payload. To minimize the system throughput delay of a commissioned EH device actuation, high-speed, optimized, machine-language assembly-code routines can be implemented to provide this computationally intensive analysis procedure.

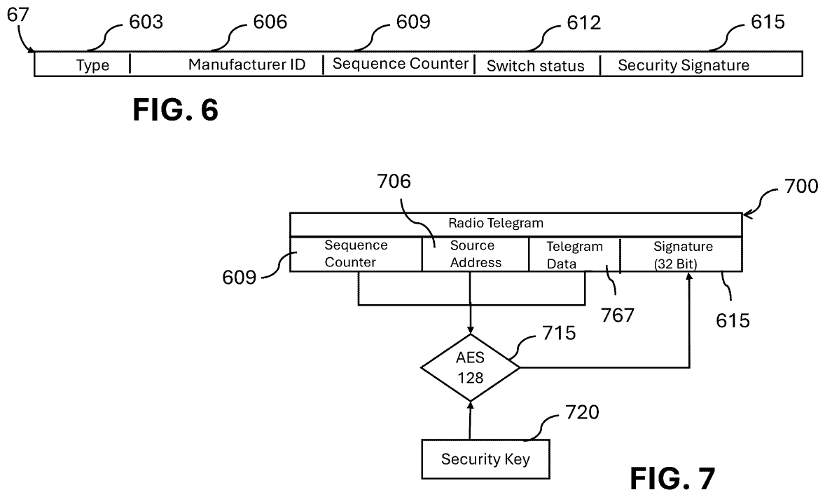

Returning back to FIG. 4, after verifying the source address of the received EH switch telegram at 415, the telegram payload field 67 is processed at 425 and parsed to obtain and further verify information and operating switch parameters in the payload data. FIG. 6 shows the telegram payload field 67 having the following data including, but not limited to: a data type 603 identifying a data type used for the telegram; a manufacturer identifier 606 that identifies the manufacturer of the BLE device based on an assigned number; the current value of sequence counter 609 which is the continuously incrementing counter used for security processing initialized at the time of production and incremented for each telegram sent; the EH switch status parameter value 612 reporting the current push-button action; and the resulting security signature 615 used to authenticate radio telegrams.

For example, as part of the payload data processing, to determine the EH Switch button encoding, the ESG receiver device RUC identifies the EH switch status parameter value 612 within the telegram payload field 67 the EH switch button action (e.g., button push or release). At the EH switch 50, the following sequence can be used by the EH switch button to identify and transmit button contact status: 1. Determine direction of the energy bow movement (Push Action or Release Action); 2. Read input status of all the button contacts; 3. Calculate data payload; and 4. Calculate security signature. In the EH switch, the type of action (e.g., press action or release action) is indicated by a bit value (e.g., ‘0’or ‘1’).

In an embodiment, EH switch 50 implements telegram authentication for transmitted data telegrams to ensure that only telegrams from transmitters using a previously exchanged security key will be accepted by the ESG receiver device 100. Authentication relies on a 32-bit telegram signature which is calculated as shown in FIG. 7 depicting telegram authentication flow.

As shown in FIG. 7, the current value of sequence counter 609, source address 706 and the remaining telegram data 767 together form input data 700 for application of a signature algorithm used to form payload authentication signature. This signature algorithm uses AES128 encryption based on the device-unique random security key 720 to generate a signature (e.g., 32 bits) which will be transmitted as part of the radio telegram. The signature is therefore dependent both on the current value of the sequence counter 609, the source address 706 and the remaining telegram data 767. Changing any of these three parameters will result in a different signature. At 715, the three parameter values are hashed using AES 128 encryption using the switch's device-unique random security key 720 to obtain the resulting security signature 615 included as part of the telegram payload field 67.

Returning to FIG. 4, upon or prior to EH switch 50 payload data processing at 425, FIG. 4, a further or optional security step is performed to verify the authentication signature 68 provided as part of the telegram processing. In an embodiment, the EH Device telegram authentication signature processing is implemented in the RUC at 430, FIG. 4 follows the recommendation described in Internet Engineering Task Force (IETF) Request for Comments (RFC) 3610—Advanced Encryption Standard: Counter with Cipher Block Chaining-Message Authentication Code. In such signature authentication processing, using the authentication signature 68, the RUC formulates a NONCE (Number used once) constructed as a concatenation of the device source address number and a device sequence counter number and possible padding bits and in accordance with the RFC 3610 standard, generates RFC 3610 variable internal parameters.

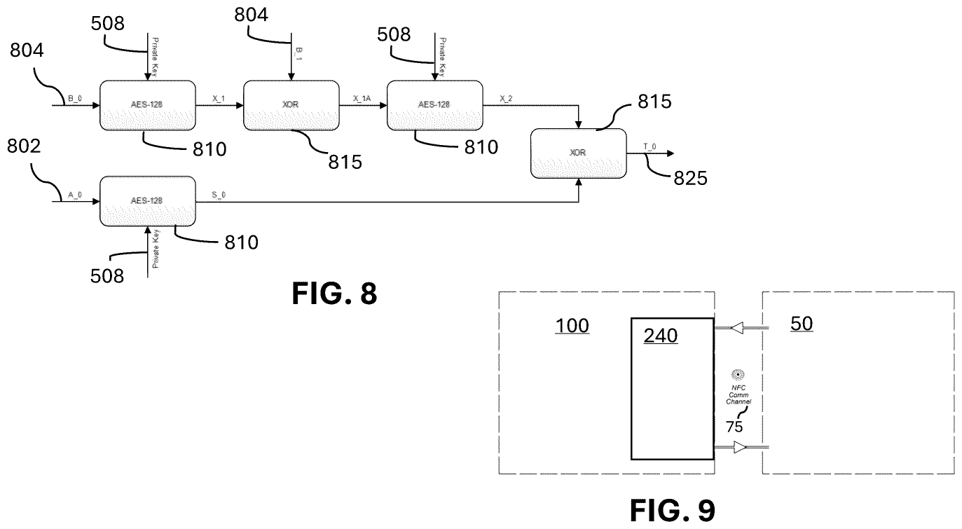

FIG. 8 depicts an algorithm execution sequence to verify authentication signature via RFC 3610 based block cipher mode. As shown in FIG. 8, the shared security key, i.e., IRK 508 and formulated RFC 3610 variable internal parameters “A0 ” 802 and “B0 ” 804 and “B1 ” 806 are processed implementing data telegram authentication based on AES128 in CCM (Counter with CBC-MAC) mode as described in IETF RFC 3610. In an embodiment, an authentication vector 825 is generated using three AES128 operations 810 and two XOR operations 815 as shown in FIG. 8 Then, the system compares the signature generated using bytes from the authentication vector 825 computed based on AES128 in CCM to generate a signature. This signature is then compared to the authentication signature 68 appended to the telegram payload field 67 and they should be matched for authentication.

Returning to 430, FIG. 4, after the ESG receiver device 100 has validated that the wireless data message originates from a trusted transmitter (as identified by its security key) and that its content is valid, it is required to avoid wireless data message replay (i.e., capture and retransmission of a valid wireless data message). In one embodiment, to avoid wireless data message replay, it is required that the ESG receiver tracks the value of the sequence counter used by the EH switch device and only accepts wireless data messages with higher sequence counter values (i.e., not accepts equal or lower sequence counter values for subsequent telegrams) exchanged as part of the radio telegram. To achieve this, the EH switch device 50/50′ includes transmission of an incrementing sequence counter within its advertisement payload data for every switch actuation. The sequence counter transmitted by the EH switch device for every commissioned unit within the ESG is tracked by the ESG receiver's RUC 200 using the FRAM module 175. If a sequence value received is less than or equal to the last detected sequence value for a particular device, an error is flagged and sent as a message to the MUC 250. The MUC 250 then indicates a possible integrity issue with that commissioned device to a Cabin Experience Network (CEN). Alternatively, if a sequence value received exceeds the last detected sequence value for a particular device, no error message is flagged.

Continuing to FIG. 4, at step 435, as part of the RUC process of screening detected EH wireless data messages based on this database of commissioned devices, a 24-bit cyclic redundancy check (CRC) error-correcting code is provided in all datagrams to verify integrity of the wireless data message. For example, a fixed byte BLE checksum 69 in the form of a CRC (cyclic redundancy check) of the BLE datagram header, source address and payload fields are used to verify data integrity of the EH switch data telegram. In an embodiment, telegram data integrity via CRC follows the BT-SIG standard for BLE advertisements.

Finally, after verifying the integrity of the received EH switch data telegram at 435, then, at 450, the RUC presents a wireless data message of the identified switch's actuation event for the MUC 250 to communicate with the control processor of the cabin management system 20 or CEN of the aircraft. As the RUC 200 identifies and sorts any redundant telegrams received by the transceivers therefore, only a single switch actuation event is provided to the MUC 250 for processing. Referring back to FIG. 3A, in an embodiment, the RUC can forward the status of the switch/sensor data to the MUC 250 for transmission of the status and switch/sensor data as a datagram packet (UDP) once all validations are checked. The MUC 250 performs other tasks such as communicating on the Ethernet interface to send the results back to the main controller and other tasks such as providing POE commands to the CEN 300.

In particular, as shown in FIG. 3B, showing a portion of the ESG receiver device, the MUC 250 processes switch actuation events and performs configuration and provisioning of EH devices using integrated near field communications (NFC) reader 230. As referred to herein, the transferring of the configuration parameters to an EH switch 50 is “provisioning”, the adding of that provisioned EH switch 50 to the ESG supported database is “commissioning”. The MUC further generates and populates the FRAM module 175 shown in FIG. 3A including a database of authenticated and commissioned devices to provide to the RUC 200. The MUC 250 further supports 10/100base-T Ethernet TCP/IP processing as shown by connections to network Interface Circuit 275 and Power Over Ethernet (POE) interface 280 providing a UDP socket communication, e.g., for transferring EH switch activity to a server 302 of the CEN 300 via an RJ45 POE connection 281.

As further shown in FIG. 3B, the MUC 250, in response to received EH switch activity, further provides user visual and audible cues reflecting status of the EH gateway system. Such cues can be in the form of audible alarm, e.g., buzzer 282, or visual cues such as LED indicators 284 for indicating an online state or status. The MUC 250 further is provisioned to receive commands from external push-buttons 295 interfacing with the MUC. These external push-buttons 295 provide convenient programmable scripts to be executed for performing operations such as one press EH device commissioning and multi-ESG configuration cloning from encrypted parameters stored on a Secure Access Module (SAM) 240. Additional scripts can be created and linked to these push-buttons for support of any functionality requirement.

Further, as shown in FIGS. 3A, 3B, the MUC 250 and RUC 200 each use a respective In-circuit serial programming (ICSP) port 205, 305 respectively, for development, programming, scripting and debug of the algorithms and processing that these devices perform. Although not shown, both RUC 200 and MUC 250 of the EH Gateway can be provided with dual USB virtual communication ports (VCP) to support both RUC and MUC in-field firmware configuration, monitoring and maintenance.

In an embodiment, the MUC 250 further includes parsing/processing to support multi-ESG receiver device configurations via ENET backbone communications using Master/Slave topology. This effectively provides RF antenna diversity to combat multi-path fading and low RSSI issues to all EH switch devices. In an embodiment, a master ESG receiver device is defined as the sole interface to the main controller of the CMS 20. It manages receive parsing of any unique or redundant EH switch actuation ethernet UDP messages from the slave ESGs. Subsequently, transmission of the parsed sole independent EH switch actuation event is relayed to the main controller of the CMS 20 via an ethernet UDP datagram.

In a further embodiment, as shown in FIG. 3B, to provide even further security enhancement during EH device NFC commissioning which can conceivably be monitored via high sensitivity RF sniffing, the Secure Access Module (SAM) 240 is supported for mutual security key authentication transfers via population of the SAM to an external receptacle. The SAM can be implemented via a crypto authentication element with non-volatile secure memory storage capability such as available with the Microchip ATECC608x device packaged within a removable form factor such as the ATEK Access Technologies DataKey Token product line.

FIG. 3B further shows that portion of the ESG receiver device 100 further including a separate main microcontroller MUC 250 adapted to provide various gateway device functions including the provisioning and configuring of each EH switch device to be deployed. In FIG. 3B, the main MUC 250 of ESG receiver device 100 interfaces with the integrated near field communications reader 230 that receives near field communications 235 from the EH switch device NFC tag 70. In an embodiment, integrated NFC reader 230 is an ELATEC T4MR-F (from ELATEC Inc.) that can read many high frequency radio frequency identification (HF RFID) technologies (e.g., from 13.56 MHz frequency band) including NFC. Interfaced with the integrated NFC reader 230 is the secure access module (SAM) 240. This SAM 240 performs secure commissioning of EH switch devices via the integrated NFC reader 230.

In an embodiment, the SAM can also support shuttling of secure, encrypted data between a source host ESG receiver device and destination client ESGs. This would allow for convenient configurations of field installed ESG receiver devices to the CEN without the need for a USB attached, possibly nefarious laptop. EH system commissioning can only be allowed via the SAM. Additionally any commissioning capability to be implemented across the CEN ENET protocol link can be completely disabled resulting in an encapsulated, extremely high EH Gateway system security level.

In alternate embodiments, ESG receiver device configuration cloning can also be implemented which allows for convenient addition of a new ESG receiver device to a multi-ESG installation. The SAM can also be configured to only target specific ESG receiver device encrypted serial numbers. Therefore, if the SAM is lost or stolen, configuration integrity of only those specifically authorized ESG receiver devices may be compromised. Remedy is feasible through re-serialization of the compromised ESG receiver devices which will void any lost or stolen SAM. Therefore, the SAM acts as both an ECC crypto authentication element as well as highly secure encrypted data transfer shuttle.

The MUC 250 can program, i.e., provision each respective EH switch device with a separate identifier or address, such that each switch and a communication from that an EH switch 50 and its communications can be uniquely and quickly identified.

As commissioning is the process by which an EH switch 50 is learned into a receiver (actuator, controller, gateway, etc.), the following two tasks are required in this process: 1) provisioning the EH switch device with the unique ID (Source Address) so the ESG receiver device can uniquely identify the specific EH switch device; and 2) provisioning the EH switch device with a shared security key (e.g. random) used to authenticate its radio telegrams to ensure that the telegrams to ensure they originate from the specific switch device and have not been modified. According to an aspect of the present disclosure, the energy harvesting switch 50 is provisioned using near field communications (NFC).

In an embodiment, the energy harvesting switch 50 is provisioned using a near field communications (NFC) tag 70 connected to the encryption transmitter. In an embodiment, the NFC tag 70 is a 13.56 MHz NFC tag. The Near Field communications interface via NFC channel 75 to enable reading and writing of certain product parameters using an NFC compliant reader/writer at an ESG receiver device 100. The programmed product parameters allow the EH Gateway to detect the switch and its configuration. The system is configured using wireless near field communication at the time of manufacture. A technician can place the EH switch 50 near the gateway and NFC functionality can be used to access (read and write) the EH switch configuration memory and thereby configure the EH switch such as programming it with typical parameters to include security keys, device description, device location, BLE addressing mode (static or RPA), BLE advertising channel frequencies and BLE telegram interval & data rate. Additional features including switch actuation operating modes such as latched, toggled, momentary or dimming are possible. Further support to emulate operation of 2, 3, 4 or multi-way ganged switch emulation can also be configured. In an embodiment, the EH switch device is provisioned with an NFC interface requiring an NFC reader (either PC USB accessory or suitable smartphone/tablet) and an NFC SW with read, write, PIN lock, PIN unlock and PIN change functionality. The NFC reader can provide all necessary commands for the NFC interface to: read data from configuration memory and write data to configuration memory; and authenticate the user (to allow read/write of protected memory) via a PIN.

In alternate embodiments, besides NFC techniques, the EH switch device can be provisioned using a camera-based commissioning technique in which a quick response (QR) code at the EH switch 50 can be read by a commissioning tool which can then communicate read parameters to an intended ESG receiver device 100. A radio-commissioning technique can further be used in which the EH switch device communicates its parameters via special radio telegrams to the intended ESG receiver device.

FIG. 9 conceptually depicts the secure commissioning of custom EH switch devices 50/50′. In FIG. 9, the SAM 240 couples to the EH switch 50/50′ via NFC channel 75 where, in an embodiment, the SAM 240 can commission the EH switch 50/50′ using Elliptic Curve Cryptography (ECC) with Asymmetric Keys (e.g., Private and Public). In this embodiment, there would be 2 pairs of ECC keys: One set for the ESG receiver device and one set for the EH switch. During EH switch provisioning by the ESG receiver device 100, the configuration parameters are hashed and signed with the ESG receiver device private key using an Elliptic Curve digital signature algorithm. This signature is then included with the configuration parameters across the NFC channel 75 to the EH switch 50/50′. There is also a random challenge query included in the transfer to the EH switch. The EH switch then verifies the transfer/configuration using the ESG Public Key located in its immutable flash memory. Similarly, the verification results and random challenge response are then encrypted via the EH switch Private Key and transferred back to the ESG receiver device. The ESG receiver device then verifies the correct challenge response based on its immutable EH Public Key. If valid, the EH switch provisioning verification results are interpreted to determine if it will be added to the commissioned devices database. This commissioning scheme should protect from any entity attempting to create a commissionable nefarious EH switch since the ESG receiver device 100 and EH switch private keys will not be known. Any man-in-the-middle attacks across NFC are circumvented with the bidirectional ECC transfers since the nefarious device will not be commissioned. Even if the nefarious device has valid BLE telegram AES-128 encryption keys (used to encrypt the telegram payload data and RPA) to deem it as a credentialed EH switch, it would not have been commissioned to the acceptable EH switch database.

While embodiments herein contemplate EH switches 50 for point-to-point applications using unencrypted wireless data messages that can be monitored and replayed, for an aircraft vehicle environment, a secure solution is provided that implements encryption. The BLE protocol provides for encrypted Resolvable Private Address (RPA) (e.g., wireless data messages can be recorded and played back). In an embodiment, the EH switch 50 itself is further configured with a counter device so that each wireless data message communicated from the EH switch 50 can have a unique number associated with it. Thus, a counter number is part of the EH switch's encrypted payload to ensure that the microcontroller can detect replay attacks. The FRAM module 175 is configured to retain counter sequences through power cycles and enable fast decoding and analysis of received wireless data messages.

Thus, the present disclosure provides an enhanced EH switch device solution by adding encrypted payloads that cannot be spoofed and replayed and is configurable using wireless near field communication. A gateway receiver connected by Power-Over-Ethernet is further utilized to monitor all the switches in the aircraft and send the commands (e.g., switch status parameter command) back to the main processor of the CMS 20. The solution allows for large scale, secure, monitoring of hundreds of switches and requires no connectors, wires, or batteries.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As used herein, the term “processor” may include a single core processor, a multi-core processor, multiple processors located in a single device, or multiple processors in wired or wireless communication with each other and distributed over a network of devices, the Internet, or the cloud. Accordingly, as used herein, functions, features or instructions performed or configured to be performed by a “processor”, may include the performance of the functions, features or instructions by a single core processor, may include performance of the functions, features or instructions collectively or collaboratively by multiple cores of a multi-core processor, or may include performance of the functions, features or instructions collectively or collaboratively by multiple processors, where each processor or core is not required to perform every function, feature or instruction individually. For example, a single field-programmable gate array (FPGA) may be used or multiple FPGAs may be used to achieve the functions, features or instructions described herein.

Various aspects of the present disclosure may be embodied as a program, software, or computer instructions embodied or stored in a computer or machine usable or readable medium, or a group of media which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided, e.g., a computer program product.

The computer readable medium could be a computer readable storage device or a computer readable signal medium. A computer readable storage device may be, for example, a magnetic, optical, electronic, electromagnetic, infrared, or semiconductor system, apparatus, or device, or any suitable combination of the foregoing; however, the computer readable storage device is not limited to these examples except a computer readable storage device excludes computer readable signal medium. Additional examples of the computer readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an optical storage device, or any appropriate combination of the foregoing; however, the computer readable storage device is also not limited to these examples. Any tangible medium that can contain, or store, program instructions for use by or in connection with an instruction execution system, apparatus, or device could be a computer readable storage device.

A computer readable signal medium may include a propagated data signal with computer readable program code having program instructions embodied therein, such as, but not limited to, in baseband or as part of a carrier wave. A propagated signal may take any of a plurality of forms, including, but not limited to, electro-magnetic, optical, or any suitable combination thereof. A computer readable signal medium may be any computer readable medium (exclusive of computer readable storage device) that can communicate, propagate, or transport a program for use by or in connection with a system, apparatus, or device. Program code embodied on a computer readable signal medium may be transmitted using any appropriate medium, including but not limited to wireless, wired, optical fiber cable, RF, etc., or any suitable combination of the foregoing.

In the discussion and claims herein, the term “about” indicates that the value listed may be somewhat altered, as long as the alteration does not result in nonconformance of the process or device. For example, for some elements the term “about” can refer to a variation of ±0.1%, for other elements, the term “about” can refer to a variation of ±1% or ±10%, or any point therein. For example, the term about when used for a measurement in mm, may include +/0.1, 0.2, 0.3, etc., where the difference between the stated number may be larger when the state number is larger. For example, about 1.5 may include 1.2-1.8, where about 20, may include 18.0-22.0.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat. “Substantially” when referring to a shape or size may account for manufacturing where a perfect shapes, such as circular or sizes may be difficult to manufacture.

As used herein terms such as “a”, “an” and “the” are not intended to refer to only a singular entity, but include the general class of which a specific example may be used for illustration. As used herein, terms defined in the singular are intended to include those terms defined in the plural and vice versa.

References in the specification to “one aspect”, “certain aspects”, “some aspects” or “an aspect”, indicate that the aspect(s) described may include a particular feature or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

The terminology used herein is for the purpose of describing particular embodiments only and is not intended to be limiting the scope of the disclosure and is not intended to be exhaustive. Many modifications and variations will be apparent to those of ordinary skill in the art without departing from the scope and spirit of the disclosure.

1. A switch monitoring system for an aircraft vehicle comprising:
multiple push-button energy harvesting switches, each push-button energy harvesting switch associated with a user-activated device in the aircraft vehicle, each push-button energy harvesting switch having a transmitter adapted to generate a wireless data message responsive to push-button energy harvesting switch actuation;
a wireless gateway receiver, located in the aircraft vehicle, the wireless gateway receiver receiving wireless data messages from corresponding push-button energy harvesting switches of associated user-activated devices, the wireless gateway receiver having a hardware processor and an associated memory, the memory storing program instructions, the hardware processor running the program instructions configuring the hardware processor to:
parse a received wireless data message to obtain a message payload data;
detect, from the obtained message payload data, an identity of the push-button energy harvesting switch that generated the wireless data message and its corresponding user-activated device;
parse the received wireless data message to determine a message count parameter; and
validate the received wireless data message based on the determined message count parameter,
wherein the multiple push-button energy harvesting switches are monitored in the aircraft vehicle without use of a battery or a wire connection.

2. The switch monitoring system as claimed in claim 1, wherein the program instructions further configure the hardware processor to:
detect, from the obtained message payload data, a switch status parameter, indicating a press or release state of the push-button energy harvesting switch.

3. The switch monitoring system as claimed in claim 2, wherein the program instructions further configure the hardware processor to:
perform an action at the user-activated device based on the switch status parameter detected from the obtained message payload data.

4. The switch monitoring system as claimed in claim 2, wherein the aircraft vehicle comprises a centralized cabin control system processor, wherein the wireless gateway receiver transmits a command associated with the switch status parameter detected from the obtained message payload data to the centralized cabin control system processor using a Power-Over-Ethernet connection interface.

5. The switch monitoring system as claimed in claim 1, wherein a push-button energy harvesting switch is programmable with a shared security key by said wireless gateway receiver using a wireless near field communication (NFC) protocol.

6. The switch monitoring system as claimed in claim 1, wherein for a received wireless data message, said message count parameter comprises a current sequence number, said current sequence number being incremented for each wireless message sent in response to user actuating the push-button energy harvesting switch, said program instructions further configuring the hardware processor to record, in a memory storage device, a last sequence number associated with a most recent wireless data message received from the corresponding identified push-button energy harvesting switch.

7. The switch monitoring system as claimed in claim 6, wherein, responsive to receipt of the obtained message payload data, said program instructions further configure the hardware processor to:
after detecting the identity of the push-button energy harvesting switch, obtain, from said message payload data, the current sequence number;
obtain, from the memory storage device, the last sequence number recorded in association with the most recent wireless data message received from the corresponding identified push-button energy harvesting switch; and
verify that the current sequence number is a number exceeding a value of the obtained last sequence number recorded in association with the same corresponding identified push-button energy harvesting switch.

8. The switch monitoring system as claimed in claim 7, wherein if the current sequence number received is a number less than or equal to the value of the obtained last sequence number recorded in associated with the same corresponding identified energy harvesting switch, said program instructions further configure the hardware processor to:
flag an error and send the flagged error as a message to a centralized cabin control system processor.

9. The switch monitoring system as claimed in claim 4, wherein the push-button energy harvesting switch has an associated identity resolution key, said message payload data further comprises: a resolvable private address having a portion based on a shared security key and a corresponding hash value portion, wherein to identify the push-button energy harvesting switch that generated a received wireless data message, said program instructions further configure the hardware processor to:
generate, based on the resolvable private address, a corresponding private address value and a corresponding hash value;
compute a hash value based on the unique shared security key and the corresponding private address value, and
detect whether the computed hash value is equal to the corresponding hash value portion of the resolvable private address included in the message payload data, wherein the push-button energy harvesting switch is uniquely identified when the computed hash value is equal to the corresponding hash value portion of the resolvable private address included in the message payload data.

10. The switch monitoring system as claimed in claim 9, wherein if the computed hash value is not equal to the corresponding hash value portion of the resolvable private address included in the message payload data, then said program instructions further configure the hardware processor to:
obtain a new shared security key;
compute a new hash value based on the new unique shared security key and the corresponding private address value; and
detect whether the computed new hash value is equal to the corresponding hash value portion of the resolvable private address included in the message payload data, and repeating the obtaining, computing and detecting steps until such time as the computed hash value is equal to the corresponding hash value portion of the resolvable private address included in the message payload data.

11. A method for monitoring switches in an aircraft vehicle, the method comprising:
receiving, at a wireless gateway receiver located in said aircraft vehicle, wireless data messages from corresponding multiple push-button energy harvesting switches, each push-button energy harvesting switch associated with a user-activated device in the aircraft vehicle and having a transmitter adapted to generate a wireless data message responsive to push-button energy harvesting switch actuation;
parsing, using a hardware processor at the wireless gateway receiver, the received wireless data message to obtain a message payload data;
detecting, from the obtained message payload data, using the hardware processor, an identity of the push-button energy harvesting switch that generated the wireless data message and its corresponding user-activated device;
parsing, by the hardware processor, the received wireless data message to determine a message count parameter; and
validating, by the hardware processor, the received wireless data message based on the determined message count parameter,
wherein the multiple push-button energy harvesting switches are monitored in the aircraft vehicle without use of a battery or a wire connection.

12. The method for monitoring switches as claimed in claim 11, further comprising:
detecting, by the hardware processor at the wireless gateway receiver, from the obtained message payload data, a switch status parameter indicating a press or release state of the push-button energy harvesting switch.

13. The method for monitoring switches as claim in claim 12, further comprising:
performing an action at the user-activated device based on the switch status parameter detected from the obtained message payload data.

14. The method for monitoring switches as claimed in claim 12, wherein the aircraft vehicle comprises a centralized cabin control system processor, said method further comprising:
transmitting, by the hardware processor at the wireless gateway receiver, a command associated with the switch status parameter detected from the obtained message payload data to the centralized cabin control system processor using a Power-Over-Ethernet connection interface.

15. The method for monitoring switches as claimed in claim 11, further comprising:
programming, using said hardware processor at the wireless gateway receiver, a push-button energy harvesting switch with a shared security key, said programming using a wireless near field communication (NFC) protocol.

16. The method for monitoring switches as claimed in claim 11, wherein for each received wireless data message, said message count parameter comprises a current sequence number, said method further comprising:
incrementing, at the push-button energy harvesting switch, the sequence number for a wireless data message sent in response to user actuating the push-button energy harvesting switch, said method further comprising:
recording in a memory storage device, using the hardware processor at the wireless gateway receiver, the last sequence number associated with a most recent wireless data message received from the corresponding identified push-button energy harvesting switch.

17. The method for monitoring switches as claimed in claim 16, wherein, responsive to receipt of the obtained message payload data, said method further comprising:
after detecting the identity of the push-button energy harvesting switch, obtaining, from said message payload data, the current sequence number;
obtaining, from the memory storage device, the last sequence number recorded in association with the most recent wireless data message received from the corresponding identified push-button energy harvesting switch; and
verifying that the current sequence number is a number exceeding a value of the obtained last sequence number recorded in association with the same corresponding identified push-button energy harvesting switch.

18. The method for monitoring switches d as claimed in claim 17, wherein if the current sequence number received is a number less than or equal to the value of the obtained last sequence number recorded in association with the same corresponding identified push-button energy harvesting switch, said method further comprises:
flagging, using the hardware processor at the wireless gateway receiver, an error and sending the flagged error as a message to a centralized cabin control system processor.

19. The method for monitoring switches as claimed in claim 14, wherein the push-button energy harvesting switch has an associated identity resolution key, said message payload data further comprising: a resolvable private address having a portion based on a shared security key and a corresponding hash value portion, wherein the identifying the push-button energy harvesting switch that generated a received wireless data message comprises:
generating, based on the resolvable private address, a corresponding private address value and a corresponding hash value;
computing a hash value based on the unique shared security key and the corresponding private address value, and
detecting whether the computed hash value is equal to the corresponding hash value portion of the resolvable private address included in the message payload data, wherein the push-button energy harvesting switch is uniquely identified when the computed hash value is equal to the corresponding hash value portion of the resolvable private address included in the message payload data.

20. The method for monitoring switches as claimed in claim 19, wherein if the computed hash value is not equal to the corresponding hash value portion of the resolvable private address included in the message payload data, then said method further comprises:
obtaining a new shared security key;
computing a new hash value based on the new unique shared security key and the corresponding private address value; and
detecting whether the computed new hash value is equal to the corresponding hash value portion of the resolvable private address included in the message payload data, and repeating the obtaining, computing and detecting steps until such time as the computed hash value is equal to the corresponding hash value portion of the resolvable private address included in the message payload data.
